(19) United States
(12) Patent Application Publication
(10) Pub. No.: US 2025/0100175 A1
(43) Pub. Date: Mar. 27, 2025

(54) CHAINSAW

(71) Applicant: Nanjing Chervon Industry Co., Ltd., Nanjing (CN)

(72) Inventors: Yang Li, Nanjing (CN); Zhongji Xia, Nanjing (CN)

(21) Appl. No.: 18/977,041

(22) Filed: Dec. 11, 2024

Related U.S. Application Data
(63) Continuation of application No. PCT/CN2022/106938, filed on Jul. 21, 2022.

(51) Int. Cl. B27B 17/12; B27B 17/00; B27B 17/02

(52) U.S. Cl. CPC B27B 17/12; B27B 17/0008; B27B 17/02

(57) ABSTRACT

A chainsaw includes a housing; a first motor supported by the housing; a saw chain driven by the first motor to implement a cutting function; a guide bar, where an end of the guide bar is supported by the housing and the guide bar is used for supporting and guiding the saw chain; an oil pump assembly including an oil pump for pumping lubricants to lubricate the saw chain or the guide bar and an oil can for storing the lubricants; and a second motor for driving the oil pump, where the distance between the center of gravity of the first motor and the center of gravity of the second motor is less than or equal to 1 m.

This application is a continuation of International Application Number PCT/CN2022/106938, filed on Jul. 21, 2022, which application is incorporated herein by reference in its entirety.

### BACKGROUND

A chainsaw is a garden tool that uses a power device to drive the blades on a saw chain to move horizontally to cut wood or branches. In order for the chainsaw to operate stably, effective lubrication between the saw chain and a guide bar for guiding the saw chain needs to be ensured to reduce friction, which generates heat, reduces cutting efficiency, accelerates wear of parts, and consumes energy. Therefore, the chainsaw is usually provided with an oil pump assembly, lubricants are transferred by an oil pump to the guide bar or the saw chain to lubricate the guide bar or the saw chain, and the oil pump and the saw chain are driven by the same motor.

### SUMMARY

The present application provides a chainsaw. The chainsaw includes a housing; a first motor supported by the housing; a saw chain driven by the first motor to implement a cutting function; a guide bar, where an end of the guide bar is supported by the housing and the guide bar is used for supporting and guiding the saw chain; and an oil pump assembly including an oil pump for pumping lubricants to lubricate the saw chain or the guide bar and an oil can for storing the lubricants. The chainsaw further includes a second motor for driving the oil pump, where the distance between the center of gravity of the first motor and the center of gravity of the second motor is less than or equal to 1 m.

A chainsaw includes a housing; a first drive unit supported by the housing; a saw chain driven by the first drive unit to implement a cutting function; a guide bar, where an end of the guide bar is supported by the housing and the guide bar is used for supporting and guiding the saw chain; and an oil pump assembly including an oil pump for pumping lubricants to lubricate the saw chain or the guide bar and an oil can for storing the lubricants. The chainsaw further includes a second drive unit for driving the oil pump, where the distance between the center of gravity of the first drive unit and the center of gravity of the second drive unit is less than or equal to 1 m.

A chainsaw includes a housing; a first motor supported by the housing; a saw chain driven by the first motor to implement a cutting function; a guide bar, where an end of the guide bar is supported by the housing and the guide bar is used for supporting and guiding the saw chain; and an oil pump assembly including an oil pump for pumping lubricants to lubricate the saw chain or the guide bar and an oil can for storing the lubricants. The chainsaw further includes a second motor for driving the oil pump, where the nominal voltage of the first motor is U1 in volts, the nominal voltage of the second motor is U2 in volts, and the product of the nominal voltage U1 of the first motor and the nominal voltage U2 of the second motor is less than or equal to 1000 V². A chainsaw includes a housing; a first motor supported by the housing; a saw chain driven by the first motor to implement a cutting function; a guide bar, where an end of the guide bar is supported by the housing and the guide bar is used for supporting and guiding the saw chain; and an oil pump assembly including an oil pump for pumping lubricants to lubricate the saw chain or the guide bar, an oil can for storing the lubricants, and a second motor for driving the oil pump, where the second motor or the oil pump is detachably mounted to the oil can.

### BRIEF DESCRIPTION OF THE DRAWINGS

FIG. 1 is a perspective view of a chainsaw as a specific example.

FIG. 2 is a perspective view of the chainsaw in FIG. 1 with part of a housing disassembled.

FIG. 3 is a perspective view of the chainsaw in FIG. 1 with a left housing disassembled.

FIG. 4 is an exploded view of the chainsaw in FIG. 3.

FIG. 5 is a view illustrating the positional relationship between the center of gravity of a second motor and an oil outlet.

FIG. 6 is a perspective view of an oil pump assembly of the chainsaw in FIG. 1.

FIG. 7 is an exploded view of the oil pump assembly in FIG. 6.

FIG. 8 is an exploded view of an oil pump in the oil pump assembly in FIG. 6.

FIG. 9 is a sectional view of an oil pump in the oil pump assembly in FIG. 6.

FIG. 10 is a perspective view of the chainsaw in FIG. 1 with a left housing and an oil can disassembled.

FIG. 11 is a control block diagram of circuitry as an example.

FIG. 12 is a control block diagram of circuitry as another example.

FIG. 13 is a flowchart of a control method in which a second controller controls the oil output of an oil pump assembly.

FIG. 14 is a flowchart of another control method in which a second controller controls the oil output of an oil pump assembly.

FIG. 15 is a flowchart of another control method in which a second controller controls the oil output of an oil pump assembly.

### DETAILED DESCRIPTION

The present application is described below in conjunction with drawings and examples.

It is to be understood by those of ordinary skill in the art that a relative term (such as “about”, “approximately”, and “substantially”) used in conjunction with a quantity or a condition includes the stated value and has a meaning indicated by the context (for example, the term includes at least a degree of error associated with the measurement of a particular value, a tolerance (such as manufacturing, assembly, and use) associated with the particular value and the like). Such a relative term should also be considered as disclosing the range defined by the absolute values of the two endpoints. The relative term may refer to an indicated value increased or reduced by a certain percentage (such as 1%, 5%, 10% or more). A value not modified by a relative term should also be disclosed as a particular value with a tolerance.

The examples of the present application improve the lubrication efficiency of a guide bar or a saw chain and a transmission assembly of the chainsaw, reduce the consumption of lubricants, ensure the compact structure of the whole machine and stability in the oil output of an oil pump assembly, and improve the user experience.

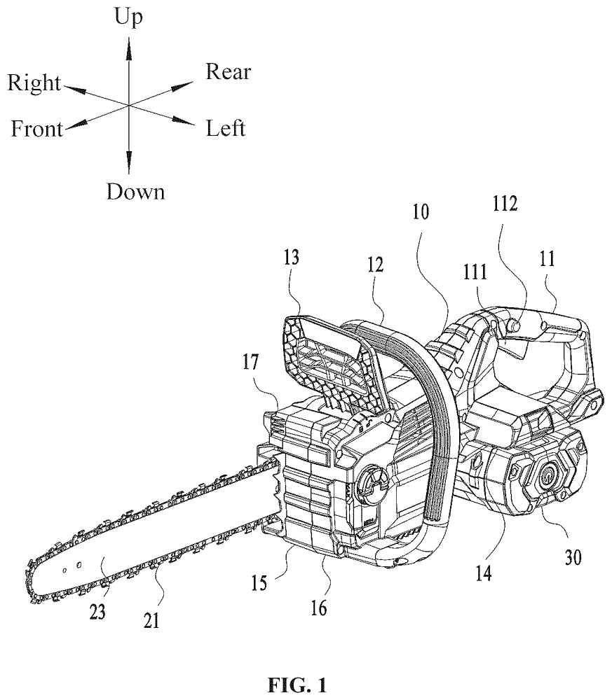

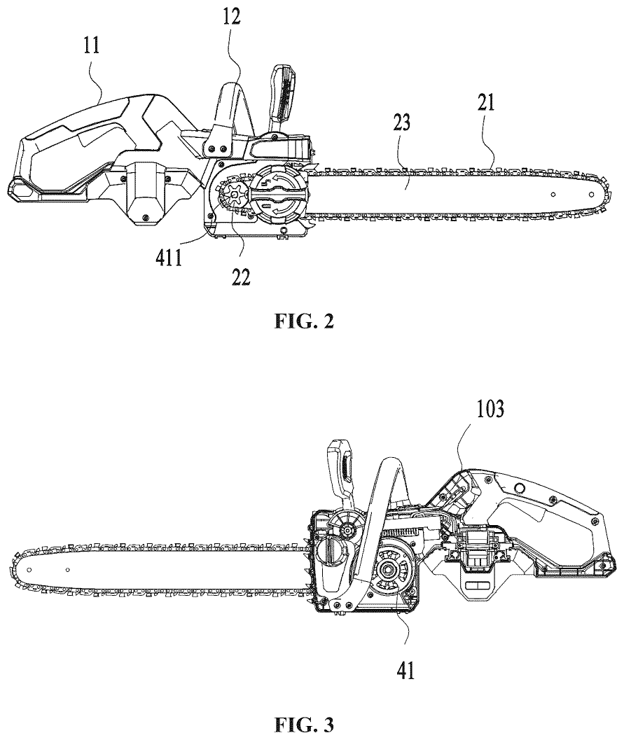

Referring to FIGS. 1 to 4, a chainsaw 100 includes a housing 10, a saw chain 21, a sprocket 22 supported in the housing 10 and capable of driving the saw chain 21 to move, and a guide bar 23 for supporting and guiding the saw chain 21. In some examples, the housing 10 includes a right housing 15 and a left housing 16, and the right housing 15 and the left housing 16 are assembled along the left and right direction to form the housing 10 and a first accommodation space 103. The housing 10 includes a main housing portion 17, and the main housing portion 17 is formed with or connected to a rear handle 11 for the user to hold and a front handle 12 for the user to lift and mate with the rear handle 11 to operate the chainsaw 100. In some examples, a switch for controlling the operation state of the chainsaw 100 is connected to the rear handle 11. In some examples, the switch includes a first switch 111 and a second switch 112. The chainsaw 100 can be started only when the user presses the first switch 111 and the second switch 112 at the same time, thereby avoiding the following: the user accidentally touches the first switch 111 to start the chainsaw 100 while holding the chainsaw 100, causing an accident. In some examples, the second switch 112 is generally used as a safety start switch, and the first switch 111 is generally used as a power-on and speed regulation switch. It is to be understood that when the chainsaw 100 is in use, the user presses the second switch 112 with the thumb and presses the first switch 111 with the index finger or the middle finger to start the chainsaw 100 and adjust the speed of the chainsaw 100.

The chainsaw 100 further includes a protective cover 13 on the front side of the front handle 12. The protective cover 13 is used for protecting the user and preventing the user from being cut by the saw chain 21 due to the recoil force when the user is operating the chainsaw 100. When the chainsaw 100 is in operation, some flying objects (such as sawdust) may be generated to scratch the surface of the user's hand holding the front handle 12.

The chainsaw 100 further includes a power supply device for supplying electrical energy required for the operation of the chainsaw 100. A power supply device 30 includes a battery pack detachably connected to a coupling portion 14 formed by the housing 10. It is to be understood that the power supply device 30 is not limited to the battery pack and may power the circuit elements through mains power or an alternating current power supply in conjunction with corresponding rectifier, filter, and voltage regulator circuits. In some examples, the power supply device 30 includes multiple battery packs for providing the chainsaw 100 with a longer battery life and a greater power output. In some examples, the total energy of the power supply device 30 is greater than or equal to 20 W·h. The maximum nominal voltage of the power supply device 30 is configured to be greater than or equal to 40 V and less than or equal to 100 V.

The chainsaw 100 further includes a first drive unit for outputting power. In this example, the first drive unit includes at least a first motor 41. The first motor 41 is disposed in the main housing portion 17. In some examples, the first motor 41 has an output shaft 411. The output shaft 411 drives the sprocket 22 to rotate. The sprocket 22 drives the saw chain 21. The saw chain 21 wraps around the edge of the guide bar 23 and can be cyclically guided by the guide bar 23. The guide bar 23 is basically distributed along the front and rear direction, an end of the guide bar 23 is supported on the housing 10, and the other end of the guide bar 23 extends out of the housing 10 along the longitudinal direction of the housing 10. For the chainsaw 100 driven by the first motor 41, especially the chainsaw 100 driven by direct current, due to the structural limitation of the chainsaw 100, the overall weight of the chainsaw 100 to which the power supply device 30 is mounted is relatively large. To reduce the fatigue of the user when operating the chainsaw 100 for a long time, the center of gravity of the chainsaw 100 needs to be set close to the front handle 12. In some examples, the first motor 41 and the saw chain 21 of the chainsaw 100 are disposed at the front end of the chainsaw 100. The power supply device 30 is disposed at the rear end of the chainsaw 100 relative to the first motor 41. The rear handle 11 is disposed on the upper side of the power supply device 30.

In some examples, the maximum output power of the first motor 41 is greater than or equal to 300 W. In some examples, the maximum output power of the first motor 41 is greater than or equal to 400 W. The nominal voltage U1 of the first motor 41 is less than or equal to 56 V.

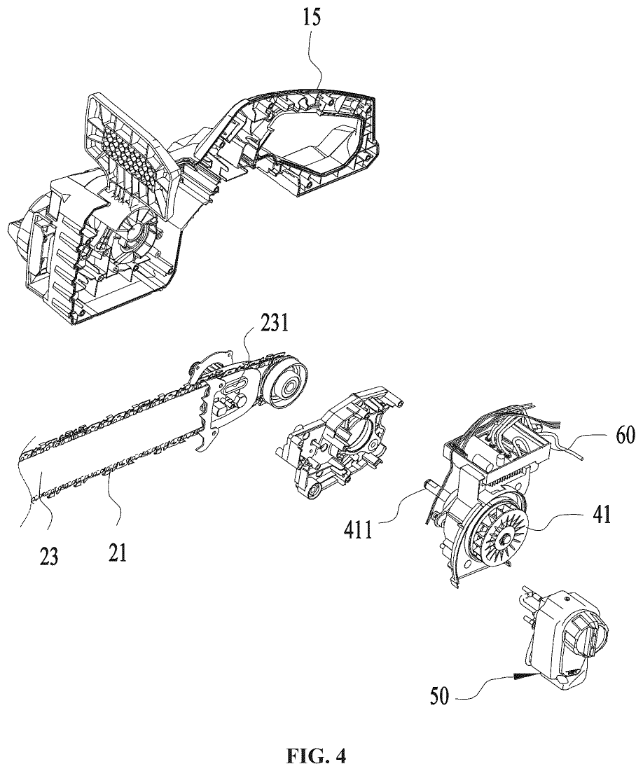

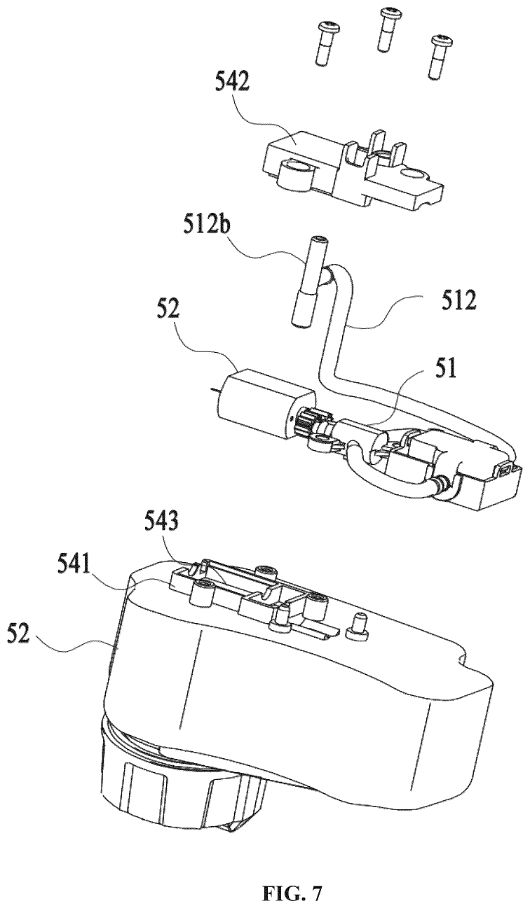

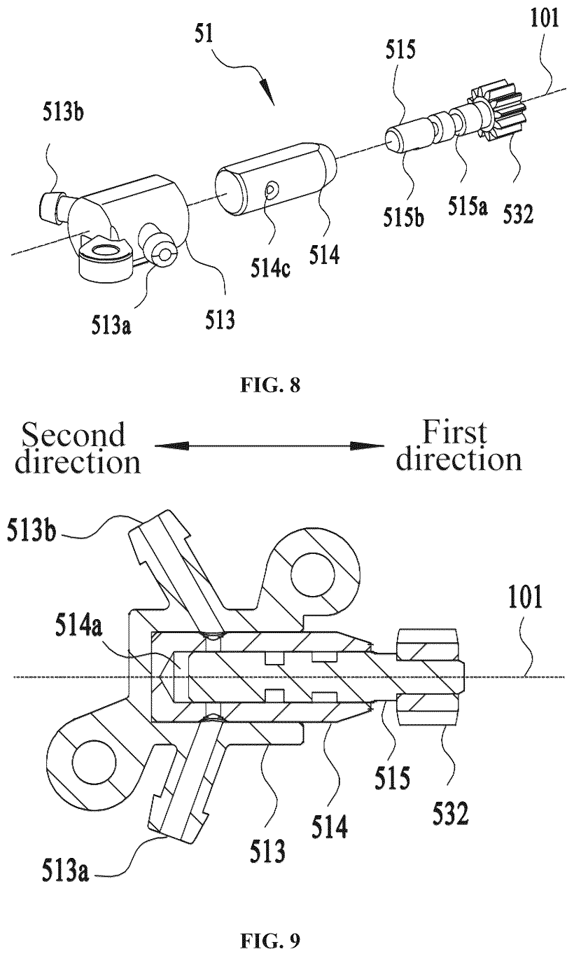

In this example, referring to FIGS. 4 to 9, the chainsaw 100 further includes an oil pump assembly 50 at least partially disposed in the first accommodation space 103 formed by the housing 10. The oil pump assembly 50 is used for lubricating the saw chain 21 or the guide bar 23 of the chainsaw 100 to improve the cutting efficiency and service life of the chainsaw 100. In some examples, the oil pump assembly 50 includes an oil pump 51 for pumping lubricants to lubricate the saw chain 21 or the guide bar 23, an oil can 52 for storing the lubricants, and a second drive unit for driving the oil pump 51. In some examples, the second drive unit includes at least a second motor 53. The second motor 53 is disposed in the main housing portion 17. In some examples, the second drive unit further includes a solenoid valve, a ceramic piezoelectric pump, or other energized motion devices. In some examples, the maximum output power of the second motor 53 is greater than or equal to 0.5 W. In some examples, the maximum output power of the second motor 53 is greater than or equal to 1 W. In some examples, the nominal voltage U2 of the second motor 53 is less than or equal to 12 V. The nominal voltage of the first motor is U1 in volts, the nominal voltage of the second motor is U2 in volts, and the product of the nominal voltage U1 of the first motor and the nominal voltage U2 of the second motor is less than or equal to 1000 V². In some examples, the product of the nominal voltage U1 of the first motor 41 and the nominal voltage U2 of the second motor is less than or equal to 800 V². V² denotes a unit formed by multiplying voltage by voltage.

In this example, the weight of the second motor 53 is greater than or equal to 200 g. In some examples, the weight of the second motor 53 is greater than or equal to 300 g. In some examples, the ratio of the weight of the first motor 41 to the weight of the second motor 53 is greater than or equal to 1.5. In some examples, the ratio of the weight of the first motor 41 to the weight of the second motor 53 is greater than or equal to 2.5. In some examples, the ratio of the weight of the first motor 41 to the weight of the second motor 53 is greater than or equal to 3.

In some examples, the oil can 52 includes a can cover 521 and a can body 522. The can body 522 and the can cover 521 are connected through threads. The can body 522 is fixedly mounted in the housing 10 and contains motor oil to lubricate the saw chain 21. In this example, the can body 522 is fixedly mounted to the left housing 15 and at least partially exposed from the left housing 15. To facilitate checking the remaining oil quantity by the user, reminder marks are set on the can body 522 and include a maximum refuel quantity mark and a minimum refuel quantity mark for reminding the user of the maximum refuel quantity and the minimum refuel quantity. In this example, the oil can 52 is located on the front side of the first motor 41 in the front and rear direction. It is to be understood that the oil can 52 may be disposed at any position in the first accommodation space 103 according to the internal structure of the chainsaw. The oil can 52 may also be disposed outside the first accommodation space 103, that is, disposed in a region outside the housing 10.

The oil pump 51 is connected to the oil can 52 and is driven by the second motor 53 to transfer the lubricants in the oil can 52 to the saw chain 21 or the guide bar 23. In some examples, the oil pump 51 is connected to an oil inlet pipe 511 and an oil outlet pipe 512. The oil inlet pipe 511 is connected to the oil can 52, and the oil outlet pipe 512 has an oil outlet port 512a near the guide bar 23. During operation of the oil pump assembly 50, the second motor 53 drives the oil pump 51 to operate, and under the action of the oil pump 51, the lubricants in the oil can 52 flows through the oil inlet pipe 511, the oil pump 51, and the oil outlet pipe 512 and then flows out from the oil outlet port 512a. The oil outlet port 512a is connected to a guide member 512b. The lubricants flow through the oil outlet port 512a and the guide member 512b and drip into an oil outlet 231 formed on the guide bar 23. When the saw chain 21 rotates around the guide bar 23, the saw chain 21 automatically takes away the lubricants dripping onto the guide bar 23, thereby achieving a lubrication effect.

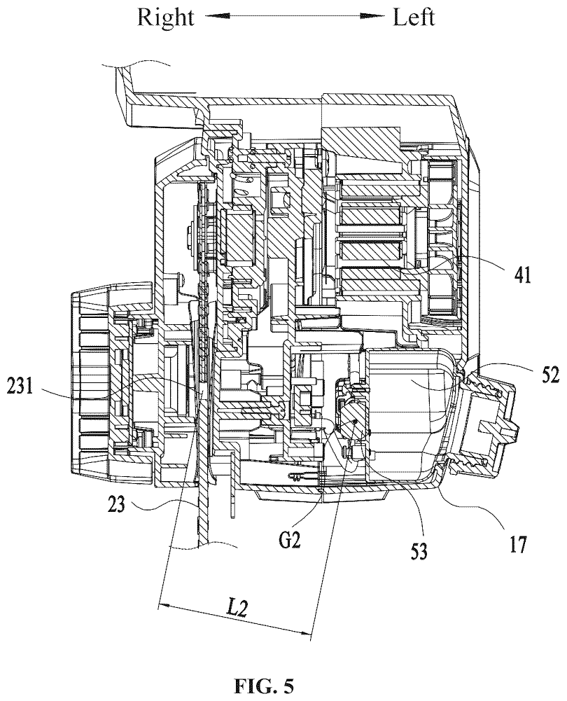

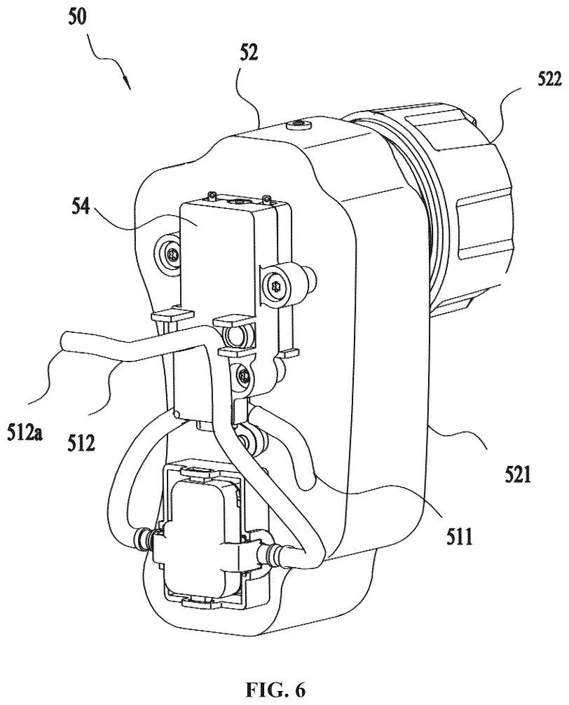

In this example, referring to FIG. 5, the distance from the center of gravity G2 of the second motor 53 to the oil outlet 231 is L2, where the distance L2 is greater than or equal to 10 mm and less than or equal to 90 mm. In some examples, the distance from the center of gravity G2 of the second motor 53 to the oil outlet 231 is L2, where the distance L2 is greater than or equal to 15 mm and less than or equal to 70 mm. In some examples, the distance from the center of gravity G2 of the second motor 53 to the oil outlet 231 is L2, where the distance L2 is greater than or equal to 25 mm and less than or equal to 50 mm. In this manner, by reasonably setting the position of the second motor 53 in the main housing portion 17, the second motor 53 is relatively close to the oil outlet 231, thereby improving the oil output efficiency of the oil pump assembly and making the structure of the whole machine relatively compact.

In some examples, a first transmission gear 531 and a second transmission gear 532 are further provided between the second motor 53 and the oil pump 51. The first transmission gear 531 is driven by the second motor 52, and the second transmission gear 532 is driven by the first transmission gear 531, thereby driving the oil pump 51 to operate. In this example, a gear transmission is provided between the second motor 53 and the oil pump 51. This is because the oil pump 51 does not require a higher rotational speed. By providing the gear transmission, the rotational speed outputted by the second motor is reduced, thereby facilitating the selection and design of the second motor. Those skilled in the art may adopt a manner in which the second motor 53 directly drives the oil pump 51.

In this example, many types of oil pumps 51 are available, such as a peristaltic pump, a diaphragm pump, a plunger pump, a vane pump, or a gear pump. Since the plunger pump has the advantages of high rated pressure, a compact structure, high efficiency, and convenient flow regulation, to improve the working stability of the oil pump assembly 50, the oil pump 51 in this example is the plunger pump. Those skilled in the art may also use other types of oil pumps during design. Next, the working manner of the oil pump assembly 50 is briefly described.

The oil pump 51 includes a cylinder block 513, a piston 514 disposed in the cylinder block 513, and a rotary shaft 515 for driving the piston 514 to operate. The cylinder block 513 has an oil inlet hole 513a and an oil outlet hole 513b. The oil inlet hole 513a is used for connecting the oil inlet pipe 511, and the oil outlet hole 513b is used for connecting the oil outlet pipe 512. The piston 514 is substantially columnar and can be driven by the rotary shaft 515 to reciprocate along the direction of a first axis 101 in the cylinder block 513. The rotary shaft 515 is driven by the second transmission gear 532 to rotate about the first axis 101. In some examples, a limiting groove 515a is formed on the rotary shaft 515, a limiting hole 514c is formed on the piston 514, a fixing pin 514d is disposed in the limiting hole 514c, an end of the fixing pin 514d is connected to the piston 514, and the other end of the fixing pin 514d is disposed in the limiting groove 515a and is movable in the limiting groove 515a along the extension direction of the limiting groove 515a. When the rotary shaft 515 is driven by the second transmission gear 532 to rotate about the first axis 101, under the action of the limiting groove 515a, the fixing pin 514d drives the piston 514 to reciprocate along the first axis 101. The piston 514 and the rotary shaft 515 form an oil chamber 514a for containing the lubricants. When the piston 514 reciprocates along the direction of the first axis 101, the volume of the oil chamber 514a changes accordingly. A cut surface 515b is further formed at an end of the rotary shaft 515. When the cut surface 515b of the rotary shaft 515 is aligned with the oil inlet hole 513a, the oil can 52 connects with the oil chamber 514a. At this time, the piston 514 moves along the first direction, and the lubricants are sucked from the oil can 52 into the oil chamber 514a through the oil inlet pipe 511 under the action of air pressure. As the rotary shaft 515 continues rotating, the cut surface 515b is misaligned with the oil inlet hole 513a, and the oil suction process ends at this time. When the cut surface 515b rotates such that the cut surface 515b is aligned with the oil outlet hole 513b, the rotary shaft 515 starts to move along the second direction. Under the action of air pressure, the lubricants in the oil chamber 514a flow into the oil outlet pipe 512 through the oil outlet hole 513b and finally flow out from the oil outlet port 512a. At this time, the oil discharging process ends. As the rotary shaft 515 rotates, the oil pump assembly 50 continuously completes the operations of sucking and discharging oil, thereby achieving lubrication of the saw chain 21 and the guide bar 23.

The working process of the oil pump assembly 50 is described below. The second motor 53 drives the first transmission gear 531 to rotate about an axis parallel to the first axis 101, thereby driving the second transmission gear 532 to rotate, the second transmission gear 532 drives the rotary shaft 515 to rotate about the first axis 101, and the rotary shaft 515 drives the piston 514 to reciprocate along the first axis 101. When the piston 514 moves along the first direction a, the oil pump assembly 50 enters an oil suction state, and when the piston 514 moves along the second direction, the oil pump assembly 50 enters an oil discharging state.

In this example, the second motor 53 directly drives the oil pump 51 or drives the oil pump 51 through a low speed ratio transmission structure. In some examples, when the oil output of the oil pump assembly 50 is 10 mL/min, the average rotational speed of the rotary shaft 515 of the oil pump 51 driven by the second motor 53 is greater than or equal to 100 rad/min. In some examples, when the oil output of the oil pump assembly 50 is 10 mL/min, the average rotational speed of the rotary shaft 515 of the oil pump 51 driven by the second motor 53 is greater than or equal to 120 rad/min.

The above describes the working manner of the oil pump in an example of the present application, that is, the working manner of the plunger pump, but those skilled in the art should understand that the plunger pumps of other structural forms or other types of oil pumps may also be used to implement the function of pumping oil.

In some examples, the oil pump assembly 50 further includes a motor housing 54 formed with a second accommodation space 543 for accommodating the second motor 53 and at least part of the oil pump 51. In some examples, the motor housing 54 includes a first part 541 and a second part 542 for forming the second accommodation space, and the first part 541 and the second part 542 are assembled by screw fastening. In this example, the first part 541 of the motor housing 54 and the oil can 52 are integrally formed. It is to be understood that the motor housing 54 may be used as an independent mechanism and assembled to the oil can 52 by fixing and mounting. In this manner, the oil pump assembly 50 formed by the oil pump 51, the oil can 52, the second motor 53, and the motor housing 54 are mounted into the housing 10. On the one hand, the structure inside the housing 10 is more compact, and the lubricant flow path is shorter, thereby improving the lubrication efficiency. On the other hand, when the oil pump assembly 50 is used as a whole, the difficulty of assembly and disassembly can be reduced, which is conducive to reducing costs and facilitating later maintenance.

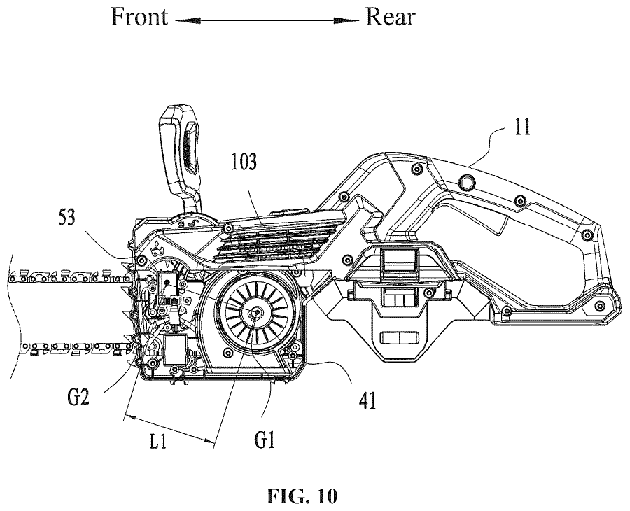

Referring to FIG. 10, in this example, the first motor 41 and the second motor 53 are disposed in the first accommodation space 103, and the first motor 41 is located behind the second motor 53 in the front and rear direction. In some examples, at least part of the first motor 41 or the second motor 53 is located between the front handle 12 and the rear handle 11 in the front and rear direction. In this example, the first motor 41 has a center of gravity G1, the second motor 53 has a center of gravity G2, and the distance L1 between the center of gravity G1 and the center of gravity G2 is less than or equal to 1 m. In some examples, the distance L1 between the center of gravity G1 and the center of gravity G2 is less than or equal to 0.7 m. In some examples, the distance L1 between the center of gravity G1 and the center of gravity G2 is less than or equal to 0.4 m. In this manner, the first motor 41 and the second motor 53 are reasonably arranged in the first accommodation space 103 so that the structure of the entire chainsaw 100 can be more compact. In this example, the length of the second motor 53 is less than or equal to 50 mm.

In this manner, by reasonably arranging the positions of the first motor 41 and the second motor 53, while the structure of the whole machine is compact, the layout of the oil circuit can be simplified, thereby improving the oil pumping efficiency. In this example, the length of the oil outlet pipe 512 is greater than or equal to 50 mm. In some examples, the length of the oil outlet pipe 512 is greater than or equal to 70 mm.

In some examples, the oil pump 51, the second motor 53, and the motor housing 54 may not be mounted on the oil can 52. In some examples, the oil pump 51, the second motor 53, and the motor housing 54 are mounted between the first motor 41 and the rear handle 11. In some examples, the oil pump 51, the second motor 53, and the motor housing 54 are mounted in the accommodation space formed by the rear handle 11. The oil pump assembly 50 may be mounted on the rear side of the first motor 41 or at other positions.

In some examples, a gearbox with a variable gear ratio is provided between the second motor 53 and the oil pump 51, and the oil output of the oil pump is changed by adjusting the gear ratio of the gearbox. In some examples, a switch for adjusting the gear ratio of the gearbox is provided on the housing 10, and the user controls the rotational speed of the rotary shaft 515 by operating the switch, thereby controlling the oil output of the oil pump assembly 50.

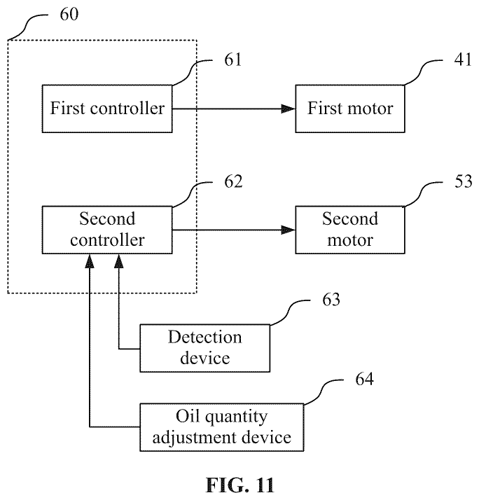

Referring to FIGS. 4 and 11, the normal operation of the chainsaw 100 further depends on the circuitry. In some examples, the chainsaw 100 further includes a circuit board assembly 60 disposed in the first accommodation space 103. The circuit board assembly 60 is electrically connected to at least the first motor 41 and the second motor 53 and used for controlling the rotation of the first motor 41 and the second motor 53. In some examples, the circuit board assembly 60 includes a first controller 61 and a second controller 62. The first controller 61 is electrically connected to the first motor 41 and used for controlling the operation of the first motor 41. The second controller 62 is electrically connected to the second motor 53 and used for controlling the operation of the second motor 53. In some examples, the chainsaw 100 further includes a detection device 63 for detecting the state of the lubricants flowing through the oil inlet pipe 511 or the oil outlet pipe 512. In some examples, the detection device 63 may be a sensor. In this example, the detection device 63 is mounted near the oil outlet pipe 512. The second controller 62 is connected to the detection device 63 for detecting the state of the lubricants flowing through the oil outlet pipe 512 in real time. The second controller 62 is configured to send a first signal to the first controller 61 when acquiring an oil shortage signal outputted by the detection device 63. The first controller 61 is configured to control the rotational speed of the first motor based on the received first signal. In this example, the first controller 61 and the second controller 62 are disposed on the same circuit board. The first controller 61 and the second controller 62 may be configured to be the same controller.

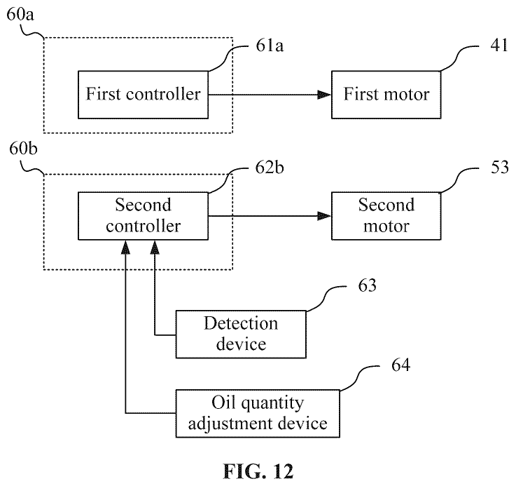

In some examples, referring to FIG. 12, the circuit board assembly includes a first circuit board assembly 60a and a second circuit board assembly 60b. The first circuit board assembly 60a is provided with a first controller 61a for controlling the operation of the first motor 41. The second circuit board assembly 60b is provided with a second controller 62b for controlling the operation of the second motor 53. In this example, the first circuit board assembly 60a and the second circuit board assembly 60b are mounted separately. As an example, the second circuit board assembly 60b is fixedly mounted on the oil pump assembly 50, and the second circuit board assembly 60b and the oil pump assembly 50 are integrated and can be detachably removed from the first accommodation space 103.

When cutting a workpiece, the user adjusts the rotational speed of the first motor 41 of the chainsaw 100 according to actual working conditions, thereby adjusting the cutting speed. When the cutting speed of the chainsaw 100 is larger, more lubricants are required. On the contrary, when the chainsaw 100 performs cutting at a lower speed or for a short period of time, fewer lubricants are required. To facilitate the adjustment of the oil output of the oil pump assembly 50 to adapt the oil output to the requirements of the user, the chainsaw 100 in this example further includes an oil quantity adjustment device 64 for adjusting the rotational speed of the second motor 53. It is to be understood that the larger the rotational speed of the second motor 53 is, the larger the oil output of the oil pump assembly 50 is. The smaller the rotational speed of the second motor 53 is, the smaller the oil output of the oil pump assembly 50 is. It is to be noted that the preceding oil output refers to the oil output of the oil pump assembly 50 per unit time, that is, the oil output of the oil outlet port 512a per minute.

In some examples, the oil quantity adjustment device 64 may be disposed on the housing 10 and used for the user to operate. In some examples, the oil quantity adjustment device 64 may be disposed on the rear handle 11 so that the user can more conveniently operate the oil quantity adjustment device 64 to adjust the current oil output of the chainsaw 100 when operating the chainsaw 100 for cutting. The oil quantity adjustment device 64 may be disposed at another position of the chainsaw 100. In this example, the oil quantity adjustment device 64 is configured to be a button, a knob, or another form.

In some examples, the chainsaw 100 does not need to be provided with a detection device for detecting the state of the lubricants. In some examples, the second controller 62 is configured to acquire the working parameters of the second motor 53 and control the rotational speed of the first motor 41 or the second motor 53 based on the acquired working parameters. The working parameters of the second motor 53 include, but are not limited to, working current, rotational speed, and torque. The second motor 53 is used for driving the oil pump 51 to transfer the lubricants in the oil can 52 to the guide bar 23. It is to be understood that when the lubricants in the oil can 52 are fewer or exhausted, the working parameters of the second motor 53 change. For example, the working current of the second motor 53 increases, the rotational speed decreases, and the torque increases. Therefore, the state of the lubricants in the oil can, that is, the presence of lubricants or the absence of lubricants, can be determined by the real-time working parameters of the second motor 53 described above.

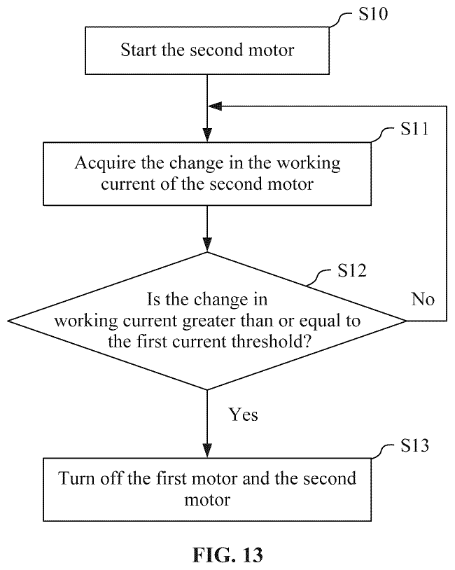

A control method for adjusting the oil output of the chainsaw is described below in conjunction with FIG. 13. The method includes the steps below.

In S10, the second motor starts.

In S11, the change in the working current of the second motor is acquired.

In S12, whether the change in the working current of the second motor is greater than or equal to a preset first current threshold is determined. If so, step S13 is performed; if not, step S11 is performed.

In S13, the first motor and the second motor are turned off.

In this manner, by setting the first current threshold, whether the lubricants in the oil can are exhausted can be directly determined. When the lubricants are exhausted, the first motor and the second motor are turned off, thereby ensuring that the saw chain does not operate in a lubricant-free state and further extending the service life of the saw chain and the guide bar.

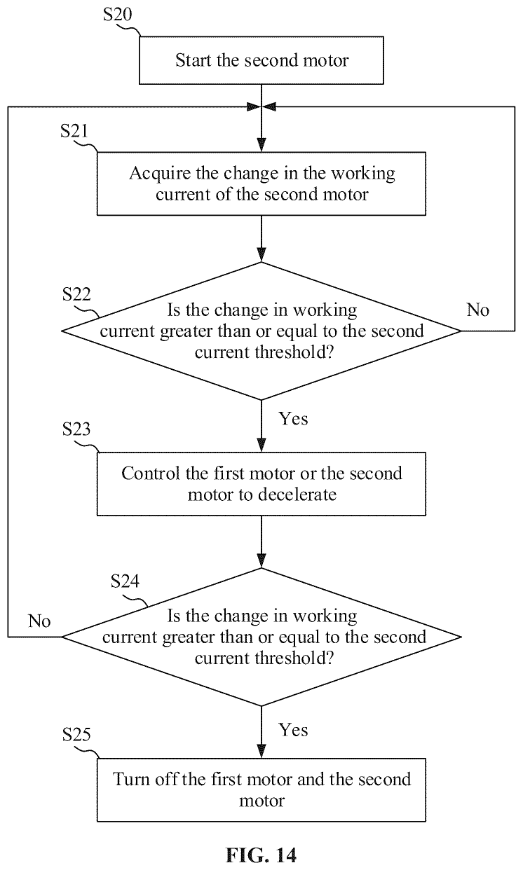

Another control method for adjusting the oil output of the chainsaw is described below in conjunction with FIG. 14. The method includes the steps below.

In S20, the second motor starts.

In S21, the change in the working current of the second motor is acquired.

In S22, whether the change in the working current of the second motor is greater than or equal to a preset second current threshold is determined. If so, step S23 is performed; if not, step S21 is performed.

In S23, the first motor or the second motor is controlled to decelerate.

In S24, whether the change in the working current of the second motor is greater than or equal to a preset second current threshold is determined. If so, step S25 is performed; if not, step S21 is performed.

In S25, the first motor and the second motor are turned off.

The difference from the preceding example is that the first current threshold and the second current threshold are set in this example, where the first current threshold is greater than the second current threshold. When the change in the working current of the second motor reaches the second current threshold, the speed of the first motor or the second motor is limited, thereby limiting the flow of the lubricants out of the oil pump. When the change in the working current of the second motor is greater than or equal to the first current threshold, the first motor and the second motor are turned off. In this manner, while it is ensured that the saw chain does not operate in the lubricant-free state, the following can be avoided: the chainsaw suddenly stops due to lack of oil, causing inconvenience to the cutting operation of the user. When the user controls the chainsaw to perform the cutting operation normally and finds that the oil output sharply decreases, the user can know that the lubricants in the oil can are about to be exhausted, end the cutting operation as soon as possible, and replenish the lubricants.

It is to be noted that the preceding control method merely uses the working current of the second motor as an example, and the control method may also be based on other working parameters, such as the changes in the rotational speed and torque of the second motor. The operation of the first motor and the second motor may also be controlled through a combination of different working parameters, for example, based on the changes in the working current and torque of the second motor. All working parameters related to the second motor that can be listed by those skilled in the art should be included in the scope of the present application.

In some examples, the second controller 62 is configured to acquire the working parameters of the power supply device and control the rotational speed of the first motor 41 or the second motor 53 based on the acquired working parameters. The working parameters of the power supply device include, but are not limited to, supply current or supply voltage. The second motor 53 is used for driving the oil pump 51 to transfer the lubricants in the oil can 52 to the guide bar 23. It is to be understood that when the lubricants in the oil can 52 are fewer or exhausted, the supply current or supply voltage outputted by the power supply device changes. For example, when the lubricants in the oil can are exhausted, the supply current or supply voltage of the power supply device increases. Therefore, the state of the lubricants in the oil can, that is, the presence of lubricants or the absence of lubricants, can be determined by the real-time working parameters of the power supply device described above.

The oil pump in the oil pump assembly usually has machining errors during machining or is prone to wear after long-term use, easily causing the oil output of the oil pump to be unstable. For example, the oil output of the oil pump assembly decreases or increases, or the oil pump discharges oil while sucking oil, thereby reducing the oil pumping efficiency. Next, a control method for an oil pump assembly whose oil output can be adaptively adjusted is described.

In some examples, the oil pump assembly 50 has a function of adaptively adjusting the oil output. It is to be understood that the oil output in this example is not adjusted by the oil quantity adjustment device. In some examples, the second controller is configured to control the second motor to start, and drive the second motor to operate at a preset rotational speed; and acquire the time for the oil pump assembly to switch from a first state to a second state, and set the preset rotational speed of the second motor based on the acquired time. When the oil pump assembly is in the first state, the lubricants in the oil can are full, and when the oil pump assembly is in the second state, the lubricants in the oil can are exhausted.

In some examples, when the time acquired by the second controller is greater than or equal to a first time threshold, the preset rotational speed of the second motor is increased; and when the time acquired by the second controller is less than a second time threshold, the preset rotational speed of the second motor is decreased. The second time threshold is less than or equal to the first time threshold.

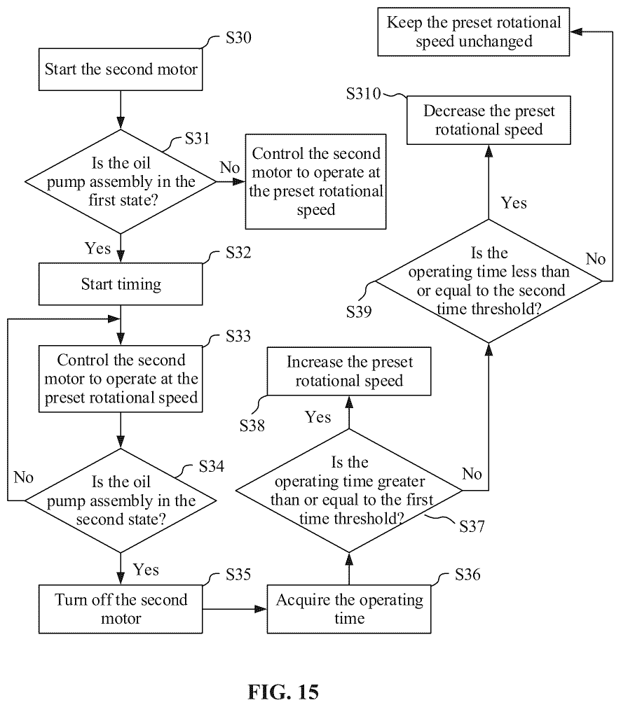

Another control method for adjusting the oil output of the chainsaw is described below in conjunction with FIG. 15. The method includes the steps below.

In S30, the second motor starts.

In S31, whether the oil pump assembly is in the first state is determined. If so, step S32 is performed; if not, the second motor is controlled to operate at the preset rotational speed.

In S32, timing starts.

In S33, the second motor is controlled to operate at the preset rotational speed.

In S34, whether the oil pump assembly is in the second state is determined. If so, step S35 is performed; if not, step S33 is performed.

In S35, the second motor is turned off.

In S36, the operating time of the oil pump assembly is acquired.

In S37, whether the operating time is greater than a preset first time threshold is determined. If so, step S38 is performed; if not, step S39 is performed.

In S38, the preset rotational speed of the second motor is increased.

In S39, whether the operating time is less than or equal to a preset second time threshold is determined. If so, step S310 is performed; if not, the preset rotational speed of the second motor is kept unchanged.

In S310, the preset rotational speed of the second motor is decreased.

In this manner, by acquiring the time it takes for the lubricants in the oil can to change from the full state to the exhausted state, the oil output of the oil pump assembly can be adaptively adjusted so that the oil output of the oil pump assembly can remain stable. In this example, the preset rotational speed of the second motor is set such that it is ensured that the oil output of the oil pump assembly is about 10 mL/min. The oil output of the oil pump assembly is stable so that the accuracy of the operable time supported by the oil quantity of the oil can and estimated by the user can be ensured, thereby ensuring the cutting efficiency and extending the service life of the guide bar and the chain.

In some examples, the chainsaw 100 further has an oil output memory function to facilitate matching the habits of the user. In some examples, the chainsaw 100 further includes a storage unit for storing the rotational speed of the second motor 53 before power is cut off. The second controller is configured to acquire a power-on signal of the second motor, query the rotational speed of the second motor in the storage unit, and control the second motor to start based on the rotational speed.

In some examples, the oil pump assembly 50 has at least a first working mode and a second working mode. In some examples, when the oil pump assembly 50 is in the first working mode, the second motor 53 continuously drives the oil pump 51 to operate to continuously output the lubricants to the guide bar. When the oil pump assembly 50 is in the second working mode, the second motor 53 intermittently drives the oil pump 51 to operate to intermittently output the lubricants to the guide bar. It is to be understood that when the user needs to operate the chainsaw 100 to perform a long-time or high-speed cutting operation, the first working mode may be selected to ensure that the chain and the guide bar of the chainsaw 100 can always be in a good lubrication state. When the user needs to operate the chainsaw 100 to perform a short-time or low-speed cutting operation, the second working mode may be selected to avoid wasting the lubricants while ensuring the lubrication effect.

In some examples, the chainsaw further includes a temperature sensor for acquiring the temperature of the guide bar or the saw chain. Since the temperature of the guide bar or the saw chain increases when the chainsaw performs cutting at a faster speed or for a longer time, more lubricants should be supplied to the guide bar or the saw chain. In some examples, the second controller acquires the temperature of the guide bar or the saw chain through the temperature sensor and adjusts the rotational speed of the second motor or the oil output of the oil pump assembly based on the acquired temperature. It is to be understood that when the temperature is relatively low, the rotational speed of the second motor may be reduced, thereby reducing the oil output of the oil pump assembly. When the temperature is relatively high, the rotational speed of the second motor may be increased, thereby increasing the oil output of the oil pump assembly. When the oil pump assembly is in the second working mode, the second motor intermittently drives the oil pump to operate to intermittently output the lubricants to the guide bar. The second controller acquires the temperature of the guide bar or the saw chain through the temperature sensor and adjusts the intermittent oil output time of the oil pump assembly based on the acquired temperature, thereby adjusting the oil output of the oil pump assembly. It is to be noted that the first controller and the second controller may be two different controllers or may be the same controller.

In some examples, the chainsaw further includes a pressure sensor for sensing a force applied by the user to the chainsaw. The pressure sensor may be mounted on the rear handle or the front handle. When the load is relatively large during the cutting process of the chainsaw, the force applied by the user to the chainsaw increases accordingly. In some examples, through the pressure sensor, the second controller acquires the force applied by the user to the chainsaw and adjusts the rotational speed of the second motor or the oil output of the oil pump assembly based on the acquired force. It is to be understood that when the force applied by the user to the chainsaw increases, the rotational speed of the second motor may be increased, thereby increasing the oil output of the oil pump assembly. When the force applied by the user to the chainsaw decreases, the rotational speed of the second motor may be reduced, thereby reducing the oil output of the oil pump assembly.

The above are merely some examples of the present application. It is to be understood by those skilled in the art that the present application is not limited to the examples described herein. For those skilled in the art, various apparent modifications, adaptations, and substitutions can be made without departing from the scope of the present application.

What is claimed is:

1. A chainsaw, comprising:
a housing;
a first motor supported by the housing;
a saw chain driven by the first motor to implement a cutting function;
a guide bar to support and guide the saw chain, the guide bar having an end that is supported by the housing;
an oil pump assembly comprising an oil pump to pump lubricants to lubricate the saw chain or the guide bar and an oil can to store the lubricants; and
a second motor to drive the oil pump, wherein a distance between a center of gravity of the first motor and a center of gravity of the second motor is less than or equal to 1 m.

2. The chainsaw of claim 1, wherein the housing comprises a left housing and a right housing that together form a first accommodation space, the first motor and the second motor are disposed in the first accommodation space, and the first motor is located behind the second motor in a front and rear direction.

3. The chainsaw of claim 2, wherein the housing is connected to or formed with a front handle and a rear handle for a user to hold, the front handle is closer to the guide bar, the rear handle is farther from the guide bar, and at least part of the first motor or the second motor is located between the front handle and the rear handle in the front and rear direction.

4. The chainsaw of claim 3, wherein the oil pump assembly further comprises an oil inlet pipe and an oil outlet pipe connected to the oil pump, the oil inlet pipe is connected to the oil can, the oil outlet pipe has an oil outlet port near the guide bar and the saw chain, and the second motor drives the oil pump to transfer the lubricants in the oil can to the oil outlet port so that the lubricants drip into an oil outlet on the saw chain or the guide bar.

5. The chainsaw of claim 4, wherein a length of the oil outlet pipe is less than or equal to 50 mm.

6. The chainsaw of claim 1, wherein a maximum output power of the first motor is greater than or equal to 300 W, and a maximum output power of the second motor is greater than or equal to 0.5 W.

7. The chainsaw of claim 6, wherein the second motor directly drives the oil pump or drives the oil pump with a low speed ratio, and a weight of the second motor is less than or equal to 200 g.

8. The chainsaw of claim 4, further comprises a circuit board assembly, wherein a first controller or a second controller is disposed on the circuit board assembly, the first controller is connected to the first motor and controls rotation of the first motor, and the second controller is connected to the second motor and controls rotation of the second motor.

9. The chainsaw of claim 8, further comprising a detection device, wherein the detection device is connected to the second controller and used for detecting a state of the lubricants flowing through the oil inlet pipe or the oil outlet pipe.

10. The chainsaw of claim 9, wherein the first controller is configured to control a state of the first motor based on the state of the lubricants acquired by the second controller.

11. The chainsaw of claim 1, wherein the oil pump comprises a peristaltic pump, a diaphragm pump, a plunger pump, a vane pump, or a gear pump.

12. The chainsaw of claim 1, further comprising a power supply device, wherein the power supply device comprises at least one battery pack detachably connected to the housing to supply electrical energy to at least the first motor and the second motor.

13. The chainsaw of claim 12, wherein a capacity of the at least one battery pack is configured to be greater than or equal to 20 W·h, and a maximum nominal voltage of the at least one battery pack is configured to be greater than or equal to 40 V and less than or equal to 100 V.

14. The chainsaw of claim 8, further comprising an adjustment device for the user to operate, wherein the adjustment device is connected to the circuit board assembly and used for adjusting at least a rotational speed of the first motor or the second motor.

15. The chainsaw of claim 14, wherein the second controller is configured to control the rotational speed of the second motor based on a trigger signal outputted by the adjustment device, thereby controlling an oil output of the oil pump assembly.

16. The chainsaw of claim 1, wherein the second motor or the oil pump is mounted to the oil can.

17. The chainsaw of claim 16, wherein the oil pump assembly and the first motor are disposed on a same side of the guide bar in a left and right direction.

18. The chainsaw of claim 16, wherein the oil pump assembly and the second motor are disposed between the guide bar and the oil can in the left and right direction.

19. The chainsaw of claim 16, wherein the oil can is formed with or connected to a motor housing to form a second accommodation space, and the oil pump and the second motor are disposed in the second accommodation space.

20. The chainsaw of claim 16, wherein the oil pump assembly further comprises an oil inlet pipe and an oil outlet pipe connected to the oil pump, the oil inlet pipe is connected to the oil can, the oil outlet pipe has an oil outlet port near the guide bar and the saw chain, and a length of the oil outlet pipe is less than or equal to 50 mm.
